(19) United States
(12) Patent Application Publication
(10) Pub. No.: US 2013/0246488 A1
(43) Pub. Date: Sep. 19, 2013

(54) LABORATORY FINDINGS PREPARATION SYSTEM FOR A MICROSCOPY WORKSTATION, PARTICULARLLY FOR USE IN THE FIELD OF CYTOLOGY

(71) Applicant: Stefan Weinschenk, Karlsruhe (DE)

(72) Inventor: Stefan Weinschenk, Karlsruhe (DE)

(21) Appl. No.: 13/639,883

(22) PCT Filed: Mar. 4, 2011
(86) PCT No.: PCT/EP2011/053301

§ 371 Date: Jun. 3, 2013

(30) Foreign Application Priority Data
Apr. 7, 2010 (DE) 10 2010 014 172.0
Apr. 7, 2010 (DE) 20 2010 004 651.3

(51) Int. Cl. G06F 17/30

(52) U.S. Cl. CPC G06F 17/30312
USPC 707/825

(57) ABSTRACT

A laboratory findings preparation system (4) for a microscopy workstation (1) having a microscope (2), particularly for use in cytology and histopathology, having: at least one input apparatus (4a) which is designed to input findings data and findings preparation instructions into the system; at least one programmable data processing apparatus (4b) operatively connected for signaling purposes to the input apparatus; a piece of laboratory management software (4c), which is set up on the basis of the findings preparation instructions to prepare laboratory findings on the data processing apparatus from a number of input findings data items; and at least one output apparatus (4f, 4g, 4h) for the laboratory findings to be prepared, operatively connected for signaling purposes to the data processing apparatus; is distinguished in that the input apparatus (4a) is designed to have a touch-sensitive user interface (4aa) on which a first plurality of input areas (4ab) can be defined essentially freely in terms of geometry and/or function, a second plurality of which is linked to a respective associated findings data item or the findings preparation instruction as stipulated by the data processing apparatus (4b, 4c, 4i) in order to transmit, when touched by an operator (5), the relevant findings data item or the findings preparation instruction for the purpose of findings preparation to the laboratory management software (4c), which is set up to prepare a finding from the received findings data and to output (4j) the finished finding via the output apparatus (4f, 4g, 4h), preferably after having received an appropriate finishing instruction from the input apparatus.

### BACKGROUND

The invention relates to a laboratory findings preparation system for a microscopy workstation with a microscope, particularly for the use in cytology and histopathology, comprising:
at least one input device embodied for entering findings data and findings preparation instructions into the system;
at least one programmable data processing device in an operative connection to an input device for signaling purposes;
a laboratory management software, which according to the findings preparation instructions is implemented for preparing laboratory findings on the data processing device from a plurality of findings data entered; and
at least one output device for the laboratory findings to be prepared, in an operative connection to the data processing device for signaling purposes.

Furthermore, the invention relates to a microscopy workstation with a laboratory findings preparation system as well as the use of an input device in the form of a touch-sensitive user interface in connection with such a microscopy workstation.

The above-defined laboratory findings preparation system and particularly its input device is also described in the following as a “table cytology” and comprises hardware and software for a more rapid digital entry of cytological and/or histopathological standard findings at a microscopy work station.

The early cancer detection in women is based on cytology as an essential foundation of diagnostics for early detection of cervical cancer. The workstation required for this purpose at the microscope demands from the operator, for example a CTA (cytological technical assistant) or a physician, a considerable extent of concentration over long periods of time. All other activities distracting from actual microscopy threaten the accuracy of findings and thus the safe diagnosis based on this work. This also includes the activity at the computer, particularly in the context with the required documentation of findings.

In the administration of medical laboratory orders and findings the digital recording of findings has not yet become standard practice. Overwhelmingly, findings are still prepared on paper using manual entries on preprinted forms stipulated by authorities (multiple form sets).

Particularly in cytology here hundreds of thousands of findings are still written manually every day. Such a procedure is time consuming, rather uneconomical, and prone to errors. FIG. 1 shows a typical cytological finding, written manually, on the common form. The finding shown in FIG. 1 is marked with the reference character B in its entirety. It particularly includes a plurality of manual entries in the section E, particularly also extensive text passages at the reference character T. The time required for preparing such findings texts range in practice from approximately 50 to 90 s.

For the above-mentioned reasons a digital recording of findings is desired, particularly for the purpose of better storage or forwarding. However, data entry via keyboards of a conventional PC-system is not possible here for several reasons: On the one hand the refocusing of the eyes of the operator, from the microscope (to the monitor), is tiring and strenuous. Additionally, the use of the keyboard leads to the operator becoming distracted, thus extending the time for preparing the findings and increasing the error rate. Furthermore, only 10 to 30% of the laboratory employees are proficient in 10-digit typing, by which a rather acceptable operating speed could be achieved. The overall analysis has shown that the data input time of findings via keyboards takes even more time than the preparation of manual findings.

### SUMMARY

The invention is based on the objective to further develop a laboratory findings preparation system and a microscopy workstation of the type respectively mentioned at the outset such that the manuscript entry of findings data via an electronic-digital input is possible in order to avoid the above-mentioned disadvantages without using a keyboard. This way, the operating speed and efficiency shall be increased and the rate of errors reduced.

The invention attains this objective via a laboratory findings preparation system, via a microscopy workstation, as well as the use of an input device in the form of a touch-sensitive surface. Advantageous further developments of the invention are the objective of the dependent claims, with their wording hereby being explicitly included in the description by way of reference in order to avoid unnecessary repetition of text.

According to the invention a laboratory findings preparation system for a microscopy workstation with a microscope, particularly for the use in cytology or histopathology, comprising:
at least one input device embodied to enter findings data and findings preparation instructions into the system;
at least one programmable data processing device in an operative connection to the input device for signaling purposes;
a laboratory processing software embodied to prepare laboratory findings, based on the findings preparation instructions, on the data processing device based on a number of findings data entered; and
at least one output device for the laboratory findings to be prepared (being) in an operative connection to the data processing device for signaling purposes, characterized in that the input device is embodied with a touch-sensitive user interface, on which a first plurality of input surfaces can be determined essentially freely with regards to geometry and/or function, with a second plurality thereof being connected, as stipulated by the data processing unit, to respectively allocated findings data or a findings preparation instruction in order to transfer, upon the touch by the operator, the respective findings data or the findings preparation instructions to the laboratory processing software to prepare the findings, which (software) is embodied such that it prepares findings from the findings data received and displays the finished prepared findings via an output device, preferably upon receipt of a respective finishing instruction from the input device.

A microscopy workstation according to the invention is characterized in comprising at least:
a preferably commercial microscope for examining samples, preferably in the field of cytology or histopathology; and
a laboratory findings preparation system according to at least one of the previous claims for preparing findings regarding the samples examined.

The application according to the invention includes the use of an input device with a tough-sensitive user interface, on which a plurality of input areas can essentially be freely defined geometrically and/or functionally, preferably of a computer input device in the form of an IntelliKeys®-input device of the company IntelliTools®, Inc. or a functionally similar input device with a tough-sensitive surface to prepare findings at a microscopy workstation in a laboratory, preferably a cytological laboratory. (The name “IntelliKeys” is a registered trademark of the company IntelliTools®, Inc., Frederick (CO), USA).

The laboratory findings preparation system according to the invention, comprising an input device in the form of a touch-sensitive user interface replaces the manuscript entry of findings data without using any keyboard. It allows the CTA a clearly structured and quick preparation of the most frequent standard findings, without the need to take his/her eyes off the microscope. For this purpose, suitable specialty hardware may be used, particularly an IntelliKeys®-input device of the company IntelliTools®, Inc., or a touch-sensitive monitor interface (touch screen). The essentially freely defined input areas on the touch-sensitive user interface are allocated to certain findings data or findings preparation instructions in order, upon a touch by the operator, transferring the respective data or the respective instruction to the laboratory management software which prepares the findings therefrom. The above-mentioned laboratory management software can represent practically any arbitrary commercially available software of this kind, which is discussed in greater detail in the following.

The finished prepared findings are either saved for further review in a common step of quality assurance in a cytological laboratory or it may be printed out in a time-saving fashion via a conventional work-station printer connected, here. The transmission via facsimile, e-mail, or the like is also possible. A considerable advantage of the report is the easily readable, uniform caption, which strikingly differs from the largely varying penmanship of different operators.

Unlike the manual preparation the operator only requires approx. 10 s for preparing a finding using the laboratory findings preparation system according to the invention, perhaps with an additional printing term of approx. 2 s.

Two general concepts are underlying the technical realization of the invention: A simplified input is particularly possible in the field of cytology due to its frequently repeating standard results, with the rate of standard findings in the overall number of findings exceeding 90%. Additionally, the “natural” recording process, i.e. the manual recording process used for 50 years can be optimally emulated, when the input field (the touch-sensitive user interface) is located in the arm radius and within the visual range of the analyzing person, thus at the place usually the sheets of paper would be placed for a manual recording of findings.

A particular further development of the invention provides for facilitating the operation such that the user interface is arranged horizontally or lying down or inclined by an angle α, α<90° in reference to the horizontal or an operating level.

Another further development of the present invention eliminates several severe disadvantages of the previous procedures in the cytological laboratory. For this purpose it uses an existing technology of the field of teaching tools/teaching systems (IntelliKeys®-surface of the company IntelliTools®, Inc.) and adapts it for a different field of technology, the one of cytological laboratory technology, so that by the application according to the invention an optimized laboratory findings preparation system develops. This has explicitly been pointed out above.

The input device used within the scope of a further development of the present invention can be operated in connection with any commercial (cytology) laboratory management program, to the extent it is conform to a use with conventional data processing devices, for example programmed on a Windows or Mac-basis, and particularly allowing the use of standardized key combinations for certain commands.

Within the scope of a preferred further development of the present invention the surface of the input device, particularly here the IntelliKeys®-input tablet, shows allocated touch-sensitive virtual “keys”, which are equivalent to the respective findings data or more complex macro commands to control the laboratory management software. This way, within the scope of another further development of the present invention, a specific “key” allocation can be generated for the input device, which has proven beneficial for a typical cytological laboratory. Here, the defined input areas are sized such and/or marked and/or arranged that the touch to prepare findings can essentially be performed by the operator without looking up from the microscope.

In particular the touch-sensitive IntelliKeys®-interface allows by a simple touching to trigger text input or (more complex) command sequences on the level of an arbitrary commercial program of the laboratory management and/or the operating system. The above-mentioned text input and/or control commands can be entered as macro-commands into the command menu of the input device or can be recorded via macro-recorders.

The use of the laboratory findings preparation system according to the invention has proven particularly beneficial in the field of cytology. In this context a particular further development of the invention provides that for the early cancer detection in women for the cytological early detection of cervical cancer at least one of the following input options is realized via the input areas:
initials of the operator for identification purposes;
pap-classification from pap I to pap V, with preferably input areas being allocated as large as possible;
additional findings typically to be yielded with every finding, particularly the proliferation from 1 to 4;
findings completion;
selection of the output device, preferably printer, facsimile, or telecommunication transmission; and
recommendations for further procedures.

As experience has taught, it is irrelevant for the analyst (physician, CTA) if he/she performs the input via a particular hardware device (tablet, preferably film-coated paper surface) or via a touch-sensitive monitor (touch screen). Within the scope of a first embodiment of the present invention it is therefore provided to use the above-mentioned hardware of the company IntelliTools®, Inc. as the input device, which is connected via USB-connections to a commercial PC. The data input by touching then triggers a command sequence similar to those of keyboards.

An alternative embodiment of the present invention provides that the operating surface comprises at least a touch screen, tablet, or touch-sensitive monitor. Although this generally leads to increased hardware costs, however it allows, particularly when only limited space is available, to waive an additional input device, because usually microscopy workstations are equipped with a monitor.

The solutions stated in the following each show advantages and disadvantages, which are listed in the following Table 1.

TABLE 1
Advantages and disadvantages of the hardware solution
using tablet versus touch screen

| Criterion | Tablet (IntelliKeys ®) | Touch screen |
|---|---|---|
| Position for the arm | Beneficial | Position standing |
| | | erect, ergonomically |
| | | disadvantageous; more |
| | | expensive when |
| | | embedded in the work |
| | | surface |
| Use of the monitor | Can simultaneously be | When using the |
| | used for other purposes and | program exclusively |
| | programs, input form of the | for the tablet |
| | laboratory program is | surface, the original |
| | displayed | laboratory program is |
| | | not visible |
| Adjustable | Simple | Very simple |
| (adaptation of the | | |
| surface) | | |
| Technical | Low | High |
| knowledge required | | |
| Hardware costs | Moderate | High |
| Maintenance | Moderate (warranty 2 | Moderate (warranty |
| | years, rare malfunctions) | depending on |
| | | manufacturer, |
| | | malfunctions possible |

The suggested laboratory findings preparation system provides an economical user interface via its touch-sensitive user interface for the cytological findings between the operator and the management software provided in the respective laboratory. Here, it may be provided for reasons of processing technology that first by way of microscopy determined (cytological) partial results are determined and entered via the user interface and/or the allocated input fields into the system until the final result has been determined. Subsequently the findings are concluded, with perhaps required additions, such as texts or corrections, for which no fixed input section has been defined, can also be entered via a mouse or a keyboard. Subsequently the data is released or the fax/print command is issued once more via the touch-sensitive user interface and/or respective input fields.

The findings prepared in this manner can either be forwarded to a second analyst to continue analyzing the findings (as explained above) or finalized, printed, and forwarded in this form, with here too preferably the operation occurs direction via the touch-sensitive user interface. Subsequently the next findings are prepared, as explained above.

A particular advantage of the present invention is seen here in the fact that each user of the laboratory findings preparation system can adjust it via the user interface to his/her own needs at any time. Here, the adjustment can occur at the beginning of the installation and/or during use. The user can perform such adjustments him/herself or have them performed by a service partner on site and/or via remote maintenance.

This means in practice a collection of requests for changes made by the analysts, based on daily routine, which subsequently can be implemented via software technology, e.g., by using the Overlay Maker™ (IntelliTools®, Inc.) Particularly in the latter case the implementation occurs in a hardware form on the user interface by the amended overlay being printed out for each input device and accordingly mounted and by all input devices being newly programmed with an appropriately adjusted configuration file. The implementation via software technology occurs analogous in case of the use of a touch screen.

The present invention provides a considerable potential for savings, which results from the simplified recording of findings and which is illustrated by the following sample calculation. Due to the fact that in the meantime many laboratories show order volumes ranging from 80,000 to 160,000 orders per year the potential savings exceed the ones shown in the following Table 2 1.5-fold to 3-fold. The return of investment amounts here to clearly less than one year. The identification “OC” represents “object carrier”. For the manual preparation of findings it is applicable: 80% of all findings are normal findings, requiring 50 s time for entry; 10% are more extensive findings (70 s); and an additional 10% are detailed findings (90 s).

TABLE 2
Time expense and costs for various types of preparing
findings

| | Term of | | | Total costs | | |
|---|---|---|---|---|---|---|
| | entry per | Min per | Hours | for a | | |
| | pap | day ([2]) | per year | laboratory | | |
| | (OC), sec | per | [3] per | sized (-> B6) | Difference | In |
| Method | [1] | operator | operator | [ [symbol] p.a.) [4] | (costs) p.a. | percent |
| Manuscript | 50.0 | 66.7 | 241.1 | 41.666.67 [symbol] | 0.00 [symbol] | 100.0% |
| Entry via | 70.0 | 93.3 | 337.6 | 58.333.33 [symbol] | 16,666.67 [symbol] | 140.0% |
| keyboard | | | | | | |
| Entry via | 10.0 | 13.3 | 48.2 | 8,333.33 [symbol] | −33,333.33 [symbol] | 20.0% |
| tablet | | | | | | |
| Framework | | | | | | |
| values | | | | | | |
| Performance | 80 | | | | | |
| per operator | | | | | | |
| per day | | | | | | |
| Size of lab | 50,000 | | | | | |
| (OC p.a.) | | | | | | |
| Hourly rate, | 60.00 [symbol] | | | | | |
| gross | | | | | | |

Explanations:

[1] average pap (95% normal findings, 5% conspicuous findings with
twice the time expense)
[2] average daily performance of a cytological technical assistant
(OC/day) see B5
[3] hourly rate (employer expenses) see B7, 217 working days per
calendar year
[4] order volume of an average laboratory (OC per year) see B6

A particular further development of the invention provides to combine the laboratory findings preparation system with a dictation and/or voice recognition software and perhaps with a dictation device or another voice recording device in order to allow longer and/or freely worded text passages being added to the findings, particularly and without limitation in the field of histopathology. Here, the voice recording is preferably controlled via the user interface of the system (start, stop, insert, etc.)

Accordingly the present invention includes a combination of input hardware and appropriate management software provided in the respective (cytological) laboratory. It allows a simplification of the daily preparation of findings for one of the central steps of microscopic laboratory findings. This way considerable cost savings result, increased safety in findings, and a simplified transmission of findings, with the present invention in many cases representing the precondition for a digital preparation of findings and a computer-controlled printing of findings in the (cytological) laboratory.

Due to the fact that the procurement and installation costs are relatively low the return of investment occurs already within less than one year. Additionally the laboratory findings preparation system generated can easily, flexibly, and continuously be adjusted to the needs of the respective users.

### BRIEF DESCRIPTION OF THE DRAWINGS

Additional features and advantages of the present invention are discernible from the following description of exemplary embodiments based on the drawing.

FIG. 1 shows cytological laboratory findings generated conventionally by hand;

FIG. 2 shows schematically a microscopy workstation equipped with the laboratory findings preparation system according to the invention;

FIG. 3 shows an enlarged detail of the input device of the workstation according to FIG. 2; and

FIG. 4 shows a detail of a laboratory findings (report) according to FIG. 1, which was prepared with the help of the laboratory findings preparation system of FIG. 2.

### DETAILED DESCRIPTION OF THE PREFERRED EMBODIMENTS

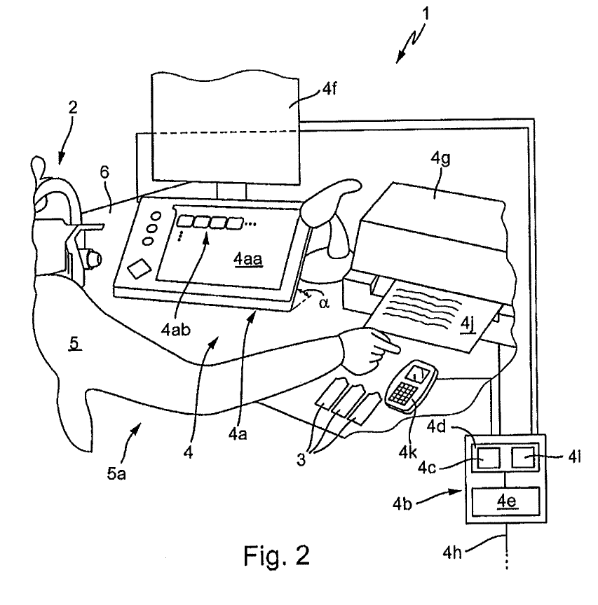

FIG. 2 shows a microscopy workstation in a cytological laboratory, which is marked in its entirety with the reference character 1. The microscopy workstation 1 shown comprises at least one microscope 2, which is shown only schematically in FIG. 2, for the examination of cytological and histopathological samples, with a number of them with the reference character 3 being also shown schematically in the form of object carriers. Furthermore, the microscopy workstation 1 comprises a laboratory findings preparation system according to the invention, which is marked in its entirety with the reference character 4. The design of the laboratory findings preparation system 4 is discussed in greater detail in the following. Furthermore, in FIG. 2 schematically an operator 5 is shown who may represent a CTA or a physician, for example.

A large portion of the above-mentioned installations is arranged on an operating surface 6, particularly a table.

The operator 5 analyzes the samples 3 with the help of a microscope 2 and subsequently prepares cytological or histopathological findings with the help of the laboratory findings preparation system 4, with its precise design now being discussed in detail:

The laboratory findings preparation system 4 comprises an input device 4a, embodied to enter findings data and findings preparation instructions into the system 4. Furthermore, the laboratory findings preparation system 4 includes a programmable data processing device 4b in the form of a commercial PC, which is in an operative connection to the input device 4a for signaling purposes. Furthermore, the laboratory findings preparation system 4 comprises commercial laboratory management software 4, which is designed for preparing laboratory findings on the data processing device 4b from a number of findings data entered according to the findings preparation instruction. According to the illustration in FIG. 2 the laboratory preparation software 4c comprises a (primary) memory 4d of the data processing device 4b, which furthermore shows at least one processor unit 4e, which is designed among other things to perform the programming instructions included in the laboratory management software 4c and process the input signals received.

Additionally the laboratory findings preparation system 4 comprises a number of output devices for the laboratory findings to be prepared, each of which being in an operative connection to the data processing device 4b for signaling purposes. According to FIG. 2, the output devices mentioned represent a monitor 4f, a printer 4g, as well as a data telecommunication connection 4h, without the invention being limited to a certain number or certain types of output devices.

The above-mentioned (primary) memory 4d of the data processing device 4b is additionally provided with driver/control software 4i to operate the input device 4a, which is to be discussed in greater detail in the following.

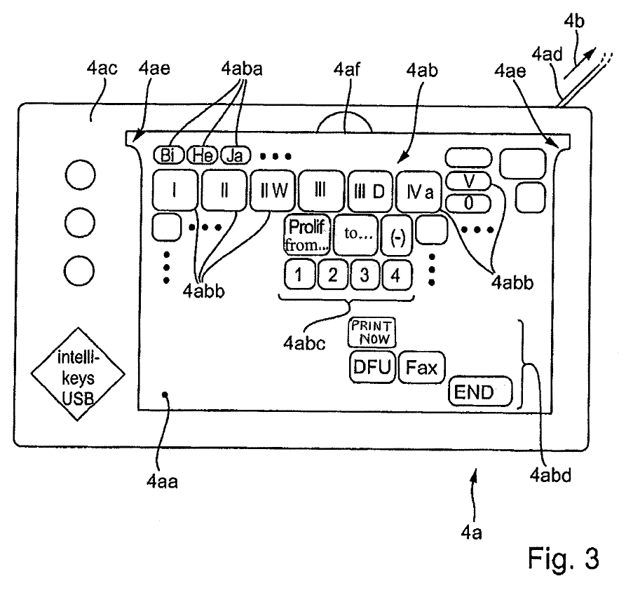

In order to operate the laboratory findings preparation system 4 the input device 4a comprises a touch sensitive user surface 4aa, on which a plurality of input areas 4ab are defined geometrically and/or functionally and which are marked, which is discussed in greater detail based on FIG. 3. When the operator 5 touches the above-mentioned input areas 4ab, particularly with his/her finger, findings data and/or findings preparation instructions are transmitted from the input device 4a to the data processing device 4b and/or to the laboratory management software 4c, which is appropriately equipped for this purpose to prepare findings via the data received, finalize them, and display the finished prepared findings via an output device, for example in the form of a print-out 4j and/or by displaying them on the monitor 4f.

In particular the microscope 2 and the input device 4a and/or its operating surface 4aa are located within the radius of the arm 5a of the operator 5. Furthermore, the input device 4a and/or its operating surface 4aa may also be placed within the view of the operator 5 when said person works at the microscope 2. The operating surface 4aa of the input device 4a is arranged inclined at an angle α in reference to the horizontal and/or in reference to the work area 6, with the angle α being clearly smaller than 90°, so that the operator 5 can scan the operating surface 4aa and reach it as easily as possible.

The operative connection to the data processing device 4b for signaling purposes comprises, in addition to the laboratory findings preparation system 4 shown in FIG. 2, also a speech recording device in the form of a dictation device 4k. Without discussing it in detail here, the above-mentioned (primary) memory 4d of the data processing device 4b also includes respective driver/control software to operate the speech recording device 4k. The latter software may also represent speech recognition software in order to directly convert the speech recorded by the speech recording device 4k into text, which then is further used to prepare the laboratory findings. Advantageously the touch-sensitive operating surface 4aa also comprises a number of input areas 4ab, which serve for the above-mentioned control of the speech recording device 4k. In principle it is also possible, of course, to enter certain findings preparation instructions not via the operating surface 4aa by via the speech recording device 4k into the system. Advantageously the speech recording device 4k is particularly used to enter longer findings texts into the system, for example in the field of histopathology.

One potential embodiment of the input device 4a and/or its user surface 4aa is now explained in greater detail based on FIG. 3. FIG. 3 shows the input device 4a of FIG. 2 in an enlarged detail. It is formed from a flat, rectangular housing 4ac, in which the touch-sensitive user surface 4aa is inserted. The input device may represent for example a device distributed by the company IntelliTools®, Inc. under the name IntelliKeys®, which is used in the field of learning tools/learning systems, particularly for children or for persons with impaired recognition. The unit and/or the input device 4a is connected and/or can be connected via a cable 4ad to a USB-connection (not shown) of the data processing device 4b according to FIG. 2. Geometric and/or functional areas, essentially freely designed, are defined and/or can be defined in the form of entry fields 4ab on the operating surface 4aa, and for this purpose respective driver/control software 41 is installed on the data processing device 4b according to FIG. 2, which has already been pointed out. Any of these input areas 4ab can be allocated via the above-mentioned driver/control software 41 to certain functions of the laboratory management software 4c, for example the entry of findings data, certain findings preparation instructions, findings output instructions, or the like. The above-mentioned entries/instructions can be recorded for example in the form of macros using conventional keyboards or a mouse (not shown) and then, upon the operator touching the respective input area 4ab, they can be recalled and/or executed.

Advantageously such input areas 4ab are defined on the operating surface 4aa as large as possible, which are required as a standard for a number of findings to be prepared. FIG. 3 shows only a few input areas 4ab in a purely exemplary fashion. Their size, arrangement, and other features (color) shall show respective user-friendly and particularly ergonomically aspects. In order to display to the operator 5 the position and function of the individual input areas 4ab in an optically discernible fashion, the input device 4ab used shows slots 4ae to accept a so-called overlay 4af laterally at the operating surface 4aa. Such an overlay 4af can be generated after the input device 4a has been programmed/functions have been allocated using a respective program of the control software 4i in an manner meeting specific requirements, printed out on paper or the like, and by inserting into the lateral acceptance slots 5ae above the actual user surface 44aa arranged so that the operator always knows the position of individual input areas 4ab. Here, the input areas 4ab may be sized and/or marked particularly such (particularly colored) that the touching by the operator can essentially occur without looking up from the microscope, thus omitting particularly the tiring refocusing of the eyes and/or considerably reducing it. Additionally, with individual input areas 4ab even longer, standardized text inputs can be connected, thus considerably accelerating the preparation of findings in reference to a digital input via a conventional keyboard.

The entries prepared in this manner are subsequently transmitted via the cable 4ad to the data processing device 4b and/or the laboratory management software 4b, which then prepares the findings and displays them via the above-mentioned periphery 4f-4h.

As easily discernible for one trained in the art the operating surface 4aa in its concrete technical embodiment is not limited to the use of the input device of the company IntelliTools®, Inc. mentioned as an example, but any other, freely programmable touch-sensitive surfaces can be used in this context, for example a touch screen, tablet, or touch-screen monitor with an appropriate driver software.

The operating surface 4aa shown in FIG. 3 with the input areas 4 as defined here is particularly suitable for the use of early cancer detection in women in the context with the cytological early detection of cervical cancer so that here particularly the following input options are realized:

The input of the initials (“Bi”, “He”, “Ja”, . . . ) of the operator for the purpose of identification occurs via the input areas 4aba. Using the input area 4abb, which for reasons of clarity is not marked in its entirety, the so-called pap-classification occurs from pap I to pap V, with here particularly the most frequently occurring pap-classifications shall be allocated to input areas as large as possible. Other input areas allow the entry of additional findings typically to be yielded for any finding, particularly the proliferation from 1 to 4 (input areas 4abc). The input areas 4abd are particularly intended for finalizing findings or for selecting output devices (printer, facsimile, or telecommunication). Further, input areas not shown and/or marked may define recommendations for further proceedings (post-findings, reexamination, revisiting, . . . )

As already mentioned, the allocation of the operating surface 4aa shown as an example in FIG. 3 is not statically predetermined but can be freely adapted to the concrete requirements in the laboratory, so that the preparation of findings can be performed accelerated, with a low error rate, and with improved clarity for reading.

In the same manner the operating surface can also be programmed for the preparation of histomorphological and histopathological findings so that accordingly particularly the following input options are realized: initials, macroscopic description of the tissue, histological findings, assessment, recommendations, finalizing findings, and release.

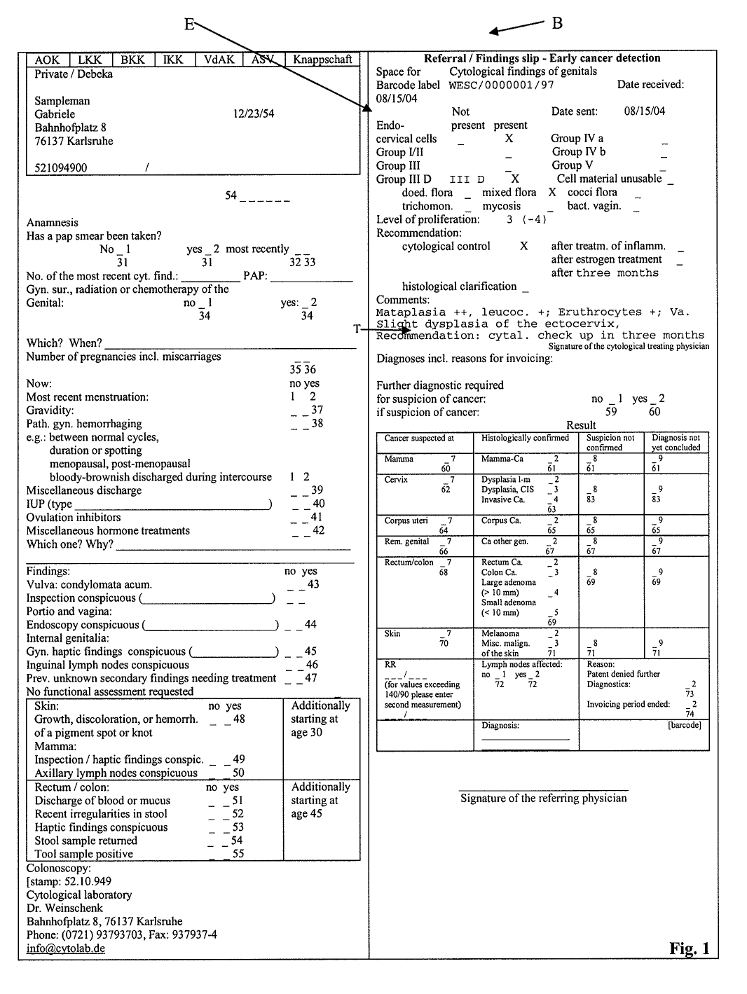

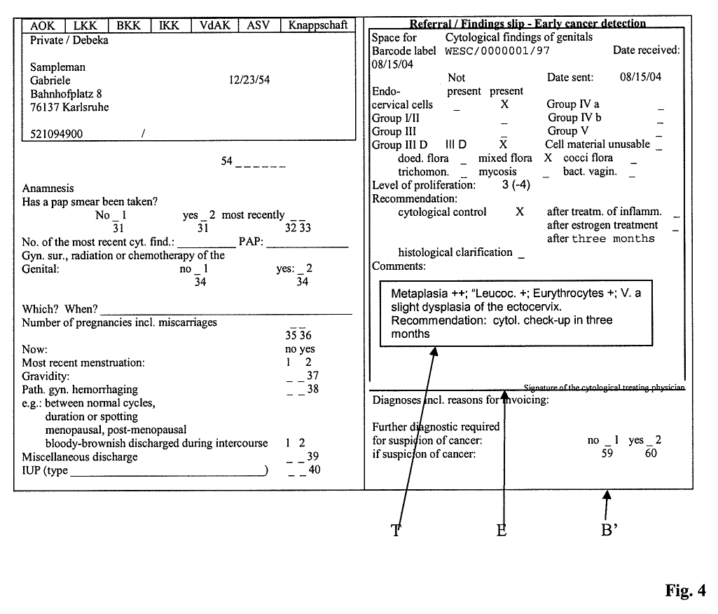

FIG. 4 shows as an example a detail from cytological laboratory findings B′ prepared with the help of the laboratory findings preparation system 4a. The entries in the field E were generated with the help of the above-described laboratory findings preparation system 4; this particularly relates to the text entry at the reference character T, by which the preparation of the findings can be considerably accelerated and according to the invention only approximately 20% of the operating time is required compared to a conventional manual preparation of the findings, with additionally the error rate being reduced and the clarity for reading is improved (cf. the illustration in FIG. 1).

1. A laboratory findings preparation system (4) for a microscopy workstation (1) with a microscope (2), comprising:
at least one input device (4a) embodied for entering findings data and findings preparation instructions into the system;
at least one programmable data processing device (4b) in operative connection to the input device for signaling purposes;
laboratory management software (4c), which according to the findings preparation instructions is implemented for preparing laboratory findings on the data processing device from a plurality of the findings data entered; and
at least one output device (4f, 4g, 4h) for the laboratory findings to be prepared, in an operative connection to the data processing device for signaling purposes,
the input device (4a) is embodied with a touch-sensitive operating surface (4aa), with a first plurality of input areas (4ab) essentially freely defined at least one of geometrically or functionally, with a second plurality being connected thereto via the data processing device (4b, 4c, 4i) with one respectively allocated one of the findings data or one of the findings preparation instruction, in order to transmit, upon a touch of an operator (5), the respective findings data or findings preparation instructions for preparing the findings to the laboratory management software (4c), which is embodied to prepare findings reports from the findings data received and to display (4j) finished prepared findings reports via the output device (4f, 4g, 4h).

2. A laboratory findings preparation system (4) according to claim 1, wherein the defined input areas (4ab) are sized such that the operator (6) can essentially touch the defined input areas for preparing findings without looking up from the microscope (2).

3. A laboratory findings preparation system (4) according to claim 1, wherein the defined input areas (4ab) with their allocated findings data cover a large portion of all potential findings contents which can occur.

4. A laboratory findings preparation system (4) according to claim 1, wherein at least a number of input areas (4ab) of a second plurality of input areas is allocated to complex functions, comprising at least one of an input of text for findings (T) or a sequence of command inputs for controlling the system.

5. A laboratory findings preparation system (4) according to claim 1, wherein the operating surface (4aa) comprises at least one computer input device in the form of an IntelliKeys®-input device.

6. A laboratory findings preparation system (4) according to claim 1, wherein the operating surface comprises at a touch screen, a tablet, or a touch-sensitive monitor.

7. A laboratory findings preparation system (4) according to claim 1, wherein the operating surface (4aa) is arranged horizontally or lying or inclined by an angle α, with α<90° in reference to horizontal or an operating surface (6).

8. A laboratory findings preparation system (4) according to claim 1, wherein the operating surface (4aa) is arranged within an arm radius and within visual range of the operator (5) working at the microscope (2).

9. A laboratory findings preparation system (4) according to claim 1, wherein for early cancer detection in women for cytological early detection of cervical cancer via the input areas (4ab) at least the following input options are realized:
initials of the operator for identification purposes (4aba);
pap-classification from pap I to pap V, with the input areas being allocated as large as possible (4abb);
additional findings typically to be yielded with every finding;
findings completion (4abd);
selection of an output device; and
recommendations for further procedures.

10. A laboratory findings preparation system (4) according to claim 1, wherein the output device is embodied as a monitor display unit (4f), a printer unit (4g), a data telecommunications unit (4h), or as a storage unit (4d).

11. A laboratory findings preparations system (4) according to claim 1, further comprising a speech recording device (4k) in operative connection to the data processing device (4b) for signaling purposes and which can be controlled via the input device (4a).

12. A microscopy workstation (1), comprising at least:
a microscope (3) for examining samples (3); and
a laboratory findings preparation system (4) according to claim 1, for preparing findings regarding the samples examined.

13. (canceled)
